(19) United States
(12) Patent Application Publication
(10) Pub. No.: US 2012/0108102 A1
(43) Pub. Date: May 3, 2012

(54) Socket for Small Card

(76) Inventor: Jung-Hoon Kim, Seoul (KR)

(21) Appl. No.: 13/350,093

(22) Filed: Jan. 13, 2012

Related U.S. Application Data
(63) Continuation of application No. PCT/KR2010/004324, filed on Jul. 2, 2010.

(30) Foreign Application Priority Data
Jul. 13, 2009 (KR) 10-2009-0063621

(51) Int. Cl. H01R 13/66

(52) U.S. Cl. 439/541.5

(57) ABSTRACT

A socket for a small card which is mounted to a circuit board. The socket includes a housing, a transfer space, a tray, and a shell. The housing includes a metal plate with a connection terminal and an insulating layer disposed on the metal plate. The transfer space is defined along both lateral portions of the housing, with a bottom surface positioned to be lower than an upper surface of the housing. The tray includes a grip portion configured to slide in the transfer space, on which either lateral end of the small card is seated. The shell positioned above and surrounding the tray and the housing.

### CROSS-REFERENCE TO RELATED APPLICATIONS

This application is a continuation of PCT International Application No. PCT/KR2010/004324 filed Jul. 2, 2010, which claims priority under 35 U.S.C. §119 to Korean Patent Application No. 10-2009-0063621, filed Jul. 13, 2009.

### FIELD OF THE INVENTION

The present invention relates to a socket for a small card, and more particularly, to a socket for a small card that is mounted on a circuit board.

### BACKGROUND

Small cards, such as Universal Subscriber Identity Module (USIM) cards, micro memory cards (Secure Digital (SD) cards), etc., are used in portable electronic appliances, and serve to store data including but not limited to user's personal information, device setting information, etc.

Portable electronic appliances continually trend to miniaturization and/or slimming in order to accommodate the preferences of consumers who regard storage convenience as important. To this end, efforts to minimize thicknesses of respective components are moving forward.

A socket, into which a small card is inserted, is generally mounted on a circuit board.

FIG. 7 schematically illustrates a conventional socket 1 having a housing 11, a shell 12, and a tray 13. The housing 11 is mounted on a circuit board 3 by soldering, and includes connection members 111a to come into contact with electrode surfaces of a small card 2 respectively. The shell 12 is spaced apart from an upper surface 11a of the housing 11 to define a space therebetween. The shell 12 is made of a metal and is grounded and fixed to the circuit board 3, thus serving to shield the interior of the socket 1 from external electromagnetic waves. The tray 13 is configured such that a small card 2 is seated therein, and is inserted in a sliding manner into the socket 1, more particularly, into the space defined between the housing 11 and the shell 12.

The housing 11 consists of a metal plate 111 and a synthetic resin layer 112. The metal plate 111 is provided with the connection members 111a and soldering pieces 111b extending from the connection members 111a so as to be mounted to electric wires of the circuit board 3. The synthetic resin layer 112 is formed on upper and lower surfaces of the metal plate 111 for the sake of insulation by, e.g., insert injection molding.

The shell 12 is shaped to surround the tray 13 placed on the upper surface 11a of the housing 11. The tray 13 has an approximately drawer shape such that the small card 2 is seated in the tray 13.

The tray 13 consists of a pair of sidewalls 132 and a bottom wall 133 extending from lower ends of the respective sidewalls 132 toward the center such that the small card 2 is supported by the sidewalls 132 and the bottom wall 133 of the tray 13. In addition, an opening 131 is perforated in the center of the bottom wall 133, to allow the connection members 111a protruding from the upper surface 11a of the housing 11 to come into contact with the electrode surfaces of the small card 2 through the opening 131.

Hereinafter, a thickness of the above described conventional socket 1 will be described with reference to FIG. 8. In FIG. 8, vertical thicknesses of the respective components are exaggerated for better understanding.

Considering the cross section of the conventional socket 1, the housing 11, the tray 13, the small card 2 and the shell 12 are sequentially stacked one above another on the circuit board 3. The above respective components have already been manufactured to have a minimum thickness to the exclusion of material improvement.

More specifically, as described above, technologies related to miniaturization of a socket have been continuously researched, and in particular, with efforts to minimize a height of the socket, thicknesses of the respective components of the socket have already been minimized to the maximum extent possible except for the case that the physical properties of the various materials of which the socket is made are taken into consideration.

Now, the minimum thicknesses of the above mentioned respective components will be described in detail. First, the metal plate 111 of the housing 11 has the same thickness as the connection members 111a. The connection members 111a are elastically moved downward upon insertion of the small card 2 and then, are returned to thereby be electrically connected to the electrode surfaces of the small card 2. Accordingly, the metal plate 111 should have the minimum thickness required at least to exhibit a restoration force of the connection members 111 a and fatigue strength against repeated insertion of the small card 2.

The synthetic resin layer 112, which is formed on the upper surface of the metal plate 111 by, e.g., insert injection molding, has the minimum thickness limited by, e.g., the material and structural shape of the connection members 111a that is bent upward from the metal plate 111. Also, the synthetic resin layer 112 formed on the lower surface of the metal plate 111 has the minimum thickness, which is required at least to insulate the metal plate 111, or is limited by a layer forming method, i.e. an insert injection molding method.

The small card 2 has a standardized thickness, and the minimum thickness of the shell 12 is limited by a required strength thereof.

In the case of the tray 13, since the bottom wall 133 of the tray 13 is a portion to be directly operated by a user, the tray 13 has the minimum thickness required to achieve a strength to prevent the tray 13 from being permanently deformed by force applied by the user.

Even if it is assumed that the respective components of the conventional socket 1 have the minimum thicknesses within an allowable range of the prior art, there still exists a need to further miniaturize a socket according to a miniaturization demand for the portable electronic appliance.

### SUMMARY

Therefore, the present invention has been made in view of the above problems, and it is one object of the invention to miniaturize a socket for a small card, which is designed to be mounted on a circuit board. It is another object of the invention to reduce a thickness of a socket for a small card while providing the socket with compatibility with a conventional tray and to assure more efficient sliding movement of a tray in the socket.

In accordance with the invention, the above and other objects can be accomplished by a socket having a housing, a transfer space, a tray, and a shell. The housing includes a metal plate with a connection terminal and an insulating layer disposed on the metal plate. The transfer space is defined along both lateral portions of the housing, with a bottom surface positioned to be lower than an upper surface of the housing. The tray includes a grip portion configured to slide in the transfer space, on which either lateral end of the small card is seated. The shell positioned above and surrounding the tray and the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a socket for a small card according to the invention;

FIG. 2 is a sectional view showing an assembled configuration of the socket shown in FIG. 1;

FIG. 3 is a sectional view showing a stopper included in the socket shown in FIG. 1;

FIG. 4 is another sectional view showing the stopper included in the socket shown in FIG. 1;

FIG. 5 is a sectional view showing another socket according to the invention;

FIG. 6 is a sectional view showing yet another socket according to the invention;

FIG. 7 is a perspective view showing a known socket; and

FIG. 8 is a sectional view showing an assembled configuration of the known socket illustrated in FIG. 7.

### DETAILED DESCRIPTION OF THE EMBODIMENT(S)

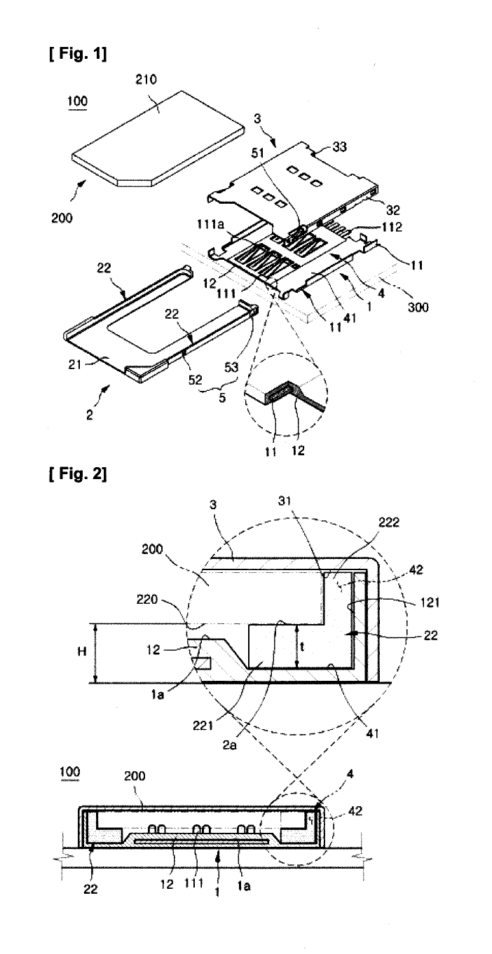

Hereinafter, functions, configurations and operations of a socket for a small card according to the exemplary embodiments of the present invention will be described in detail with reference to the accompanying drawings. It is noted that in FIGS. 2, 5 and 6, thicknesses of respective components are exaggerated for better understanding, and that in FIGS. 1 through 6, the same or similar elements are denoted by the same reference numerals even though they are depicted in different drawings.

With reference to FIGS. 1 and 2, a socket 100 for the small card 200 according to one embodiment of the invention ins shown, having a housing 1, a tray 2, and a shell 3. The shell 3 is configured to surround the tray 2 and the housing 1, and serves to intercept external electromagnetic waves that may cause interference.

The housing 1 consists of a metal plate 11 and an insulating layer 12. The metal plate 11 includes connection terminals 111, which are individually grounded to a plurality of electrode surfaces defined at a rear surface 220 of the small card 200. The insulating layer 12 is disposed on upper and lower surfaces of the metal plate 11 by, e.g., insert injection molding.

Each of the electric connection terminals 111 has a ground portion 111a to be grounded to the corresponding electrode surface (not shown) of the small card 200. Since the ground portion 111a obliquely protrudes from an upper surface 1a of the housing 1 and the electric connection terminal 111 has elasticity, the electric connection terminal 111 is elastically moved downward or upward as the tray 2, on which the small card 200 has been seated, is moved into or out of the socket 100.

The metal plate 11 is further provided at a rear end thereof with soldering pieces 112. The soldering pieces 112 are electrically connected to the respective electric connection terminals 111 and are also, are soldered to electric wires of a circuit board 300.

The insulating layer 12 is made of non-conductive synthetic resin. The insulating layer 12 disposed on the upper surface of the metal plate 11 has a height required to enable an elastic downward movement of the electric connection terminals 111. Also, the insulating layer 12 disposed on the lower surface of the metal plate 11 serves to insulate a metal plate pattern (not shown) between the electric connection terminals 111 and the soldering pieces 112 from the electric wires of the circuit board 300.

In the shown embodiment, the housing 1 internally defines transfer spaces 4 at opposite lateral sides thereof. The respective transfer spaces 4 have a bottom surface 41 located lower than the upper surface 1a of the housing 1 above the metal plate 11.

More specifically, the transfer spaces 4 may take the form of transfer recesses 42, which are defined as opposite lateral portions of the insulating layer 12 are depressed downward. In other words, the bottom surfaces 41 of the transfer spaces 4 may be the insulating layer 12 having a lower height than a conventional height.

In this case, a bottom portion 221 of the tray 2, on which the small card 200 is seated, is supported on the synthetic resin insulating layer 12. This may assure smooth sliding movement of the tray 2, thus reducing thickness loss of the bottom portion 221 due to abrasion.

In the embodiment shown, the tray 2 has an substantial box shape corresponding to the outer appearance of the small card 200 such that the small card 200 is seated in the tray 2. The tray 2 includes a front end portion 21 configured to be pulled or pushed by a user, and a pair of grip portions 22 extending from opposite sides of the front end portion 21 to support lateral ends 210 of the small card 200.

More specifically, a transversal width, i.e. a left-and-right length of the tray 2, more particularly, of the front end portion 21 corresponds to an inner transversal width of the socket 100 for the small card 200. The grip portions 22 extend rearward from opposite sides of the front end portion 21 respectively such that the electrode surfaces of the small card 200 are exposed downward through a gap between the grip portions 22.

In this way, the small card 200 is stably seated on the tray 2 such that a front end and opposite lateral ends of the small card 200 are supported by the front end portion 21 and both the grip portions 22 of the tray 2 and the electrode surfaces formed on the rear surface 220 of the small card 200 are exposed between the grip portions 22. Accordingly, the electrode surfaces of the small card 200 may be electrically connected to the electric connection terminals 111 protruding obliquely from the upper surface 1a of the housing 1 when the tray 2, on which the small card 200 has been seated, is inserted into the socket 100.

A longitudinal length, i.e. a front-and-rear length of the grip portions 22 may be equal to a length between a front end and a rear end of the housing 1. Accordingly, when the tray 2 is completely inserted into the socket 100, the front end portion 21 of the tray 2 protrudes forward from the socket 100 to allow the user to easily pull the tray 2 for separation of the small card 200.

Next, a thickness of the socket 100 for the small card 200 according to the invention will be described with reference to FIG. 2.

Each of the transfer spaces 4 takes the form of a longitudinally elongated passageway having an approximately quadrilateral cross section, and consists of the bottom surface 41 made of the insulating layer 12, an outer wall surface 121 defined by upwardly bending a left or right end of the insulating layer 12 at a right angle, and a ceiling surface 31 of the shell 3.

Each of the grip portions 22 consists of a bottom portion 221 to support the rear surface 220 of the small card 200 and a sidewall portion 222 abutting a lateral edge of the small card 200, and is inserted into the transfer space 4 in a sliding manner.

With the above described configuration, as the bottom portion 221 of the tray 2 slides on the depressed portion of the insulating layer 12 located lower than the upper surface 1a of the housing 1, it is possible to reduce the overall height of the socket 100 by a reduced thickness of the depressed portion of the insulating layer 12 while maintaining a vertical thickness t of the bottom portion 211 at a conventional level.

Furthermore, on the basis of an upper surface of the circuit board 300, an upper surface of the bottom portion 221 of the tray 2, i.e. an inner bottom surface 2a of the tray 2 that comes into contact with the rear surface 220 of the small card 200 has a height lower than a conventional level.

In conclusion, as the tray 2 slides at a lower height than the prior art, the vertical height of the socket 100 may be reduced.

The inner bottom surface 2a of the grip portion 22, on which the small card 200 is seated, may be located higher or lower than the upper surface 1a of the housing 1.

In this case, the lower the height of the rear surface 220 of the small card 200 seated on the grip portion 22, the smaller the inclination angle of the upwardly bent electric connection terminal 111.

In addition, if the inner bottom surface 2a of the grip portion 22 is located lower than the upper surface 1a of the housing 1, it may be possible to provide the front end of the housing 1 with a slope (not shown) to allow the small card 200 seated on the grip portion 22 to be smoothly inserted into the socket 100.

Referring to FIG. 1, the socket 100 further includes a stopper 5, which serves to limit sliding movement of the tray 2, so as to prevent the tray 2 from being completely discharged out of the socket 100 in the course of being moved inward or outward of the socket 100, or to prevent the tray 2 from being separated from the socket 100 regardless of the user's intention.

The stopper 5 includes an elastic piece 51 which protrudes inward from a lateral surface 32 of the shell 3, and first and second retention recesses 52 and 53 formed at longitudinal front and rear positions of the sidewall portion 222 of each grip portion 22 such that the elastic piece 51 is received in and is caught by one of the first and second retention recesses 52 and 53.

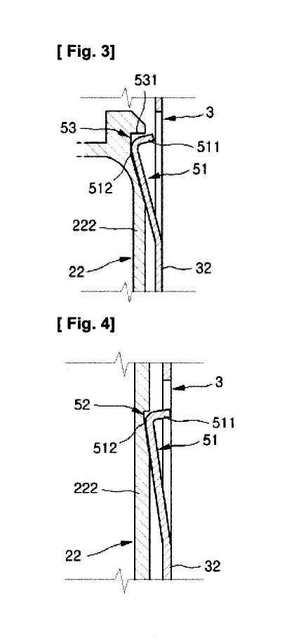

More specifically, the elastic piece 51 obliquely extends inward of the socket 100 from a front position of the lateral surface 32 of the shell 3. As illustrated in FIGS. 3 and 4, the elastic piece 51 has a distal end 511 bent outward from an angled portion 512 thereof. The angled portion 512 of the elastic piece 51 protrudes inward of the socket 100 beyond the lateral surface 32 of the shell 3, thus acting to always press the sidewall portion 222 of the grip portion 22 during sliding movement of the tray 2.

The first and second retention recesses 52 and 53 of the grip portion 22 are indented inward along the sidewall portion 222. A front end of each recess has a gentle inclination angle and a rear end of each recess has a rapid inclination angle.

Accordingly, as shown in FIG. 3, when the tray 2 is pulled forward of the socket 100, the elastic piece 51 is received in and is caught by the second retention recess 53 positioned at the rear position of the sidewall portion 222 of the grip portion 22, and the distal end 511 of the elastic piece 51 comes into close contact with a rear end surface 531 of the second retention recess 53. This prevents the tray 2 from being further moved forward and being completely separated from the socket 100.

On the other hand, as shown in FIG. 4, when the tray 2 is moved rearward and inserted into the socket 100, the elastic piece 51 is received in and is caught by the first retention recess 52 formed at the front position of the sidewall portion 222 of the grip portion 22. Thus, it may be possible to prevent the tray 2 from being discharged forward out of the socket 100 upon receiving external force, such as vibration, or due to the weight of the tray 2 so long as the user does not pull out the tray 2.

Preferably, the second retention recess 53 formed at the rear position of the sidewall portion 222 has a greater depth than that of the first retention recess 52 formed at the front position of the sidewall portion 222, to allow the elastic piece 51 to be more deeply inserted into the second retention recess 53 than the first retention recess 52. That is, owing to such a difference between the depths of the first and second retention recesses 52 and 53, the elastic piece 51 may be inserted more deeply into the second retention recess 53 and thus, a pulling force required to pull and separate the tray 2 from the socket 100 may be increased. On the other hand, when providing the first retention recess 52 with a smaller depth than the second retention recess 53, a pulling force required to pull the tray 2 mounted in the socket 100 may become smaller than a pulling force required to separate the tray 2 from the socket 100.

In FIG. 1, the shell 3 includes a downwardly bent rear end wall 33. The rear end wall 33 comes into contact with a rear end of the grip portion 22 of the tray 2 when the tray 2 is inserted into the socket 100, thereby functioning as a stopper to prevent excessive insertion of the tray 2.

Now with reference to FIG. 5, another socket 100 according to the invention is shown.

In the socket 100 for a small card, the insulating layer 12 disposed on the metal plate 11 may have a smaller transversal width than that of the metal plate 11, such that the bottom surface 41 of the transfer space 4 is made of the metal plate 11.

Accordingly, the transfer space 4 takes the form of a longitudinally elongated passage having an approximately quadrilateral cross section and consists of an outer wall surface 11a defined by upwardly bending a left or right end of the metal plate 11 at a right angle, and the ceiling surface 31 of the shell 3.

In this case, the bottom surface 41 of the transfer space 4 may be further lowered than that of the above described embodiment by a height corresponding to a height of the insulating layer 12 removed from either side of the housing 1. Consequently, the height of the socket 100 may be further reduced as compared to the aforementioned embodiment in FIG. 1.

In addition, since the bottom surface 41 of the transfer space 4 is made of the metal plate 11, an enhanced strength may be accomplished as compared to the embodiment in which the bottom surface 41 is made of the synthetic resin insulating layer 12.

As compared to the bottom surface of the transfer space which should have a thickness required to achieve a desired strength of the housing, the bottom surface of the transfer space according to the shown embodiment in FIG. 5 may have a smaller thickness, and thus, the height of the socket may be further reduced.

Other configurations and operations of the shown embodiment are identical to those of the above described above with reference to FIGS. 1-4, and thus, a repeated description thereof will be omitted.

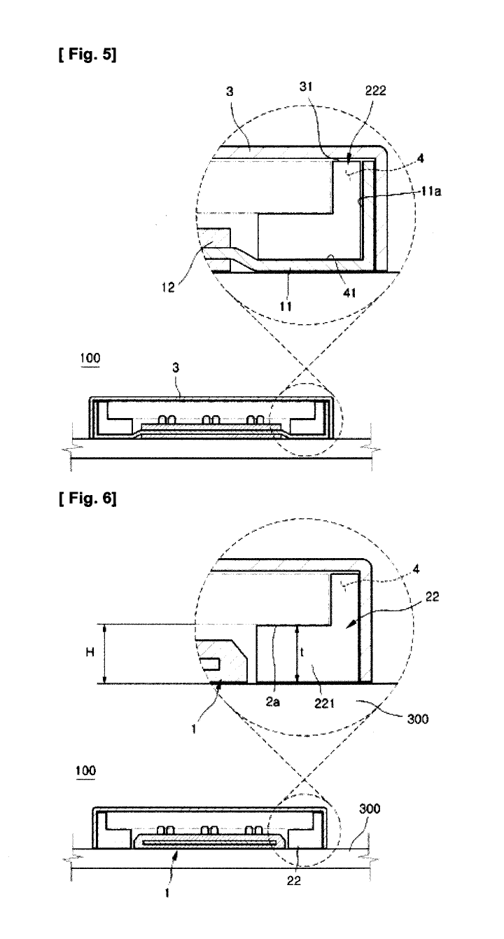

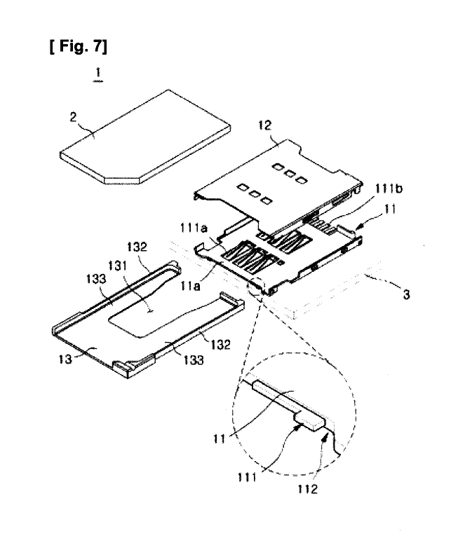

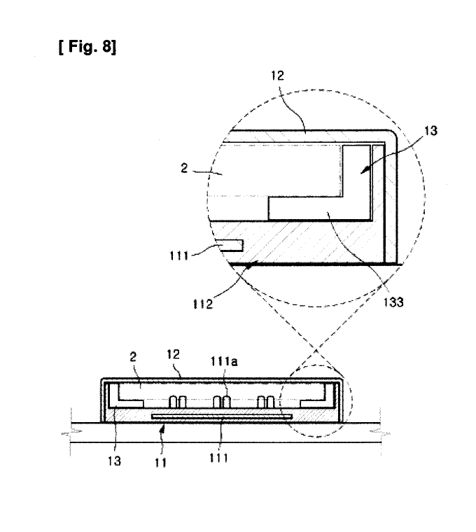

FIG. 6 is a sectional view showing another socket 100 for a small card 200 according to the invention, wherein the bottom surface 41 of the transfer space 4 is made of a surface of the circuit board 300.

The transfer space 4 may be obtained as the overall transversal width of the housing 1 is reduced to correspond to a distance between both the grip portions 22 of the tray 2 to assure smooth forward or rearward movement of the grip portions 22.

The housing 1 may be fixed to the circuit board 300 by means of the soldering pieces 112 formed at the rear end thereof and a forwardly protruding portion of the metal plate 11. In the meantime, the shell 3 may be directly soldered at a lower end of either lateral surface thereof to the circuit board 300, thereby being fixed and grounded to the circuit board 300.

In this case, the inner bottom surface 2a of the grip portion 22 has a height H equal to the thickness t of the bottom portion 221 of the tray 2, and this has the effect of reducing the vertical height of the socket 100.

Furthermore, as the bottom surface 141 of the transfer space 4 has the minimum height, the bottom portion 221 of the tray 2 may have a sufficient thickness t. Accordingly, it is possible to effectively prevent damage to the tray 2 caused when the user applies excessive force to the tray 2 in the course of moving the tray 2 inwardly or outwardly.

As is apparent from the above description, a socket for a small card according to the embodiments of the present invention may have a minimum height when being mounted on a circuit board even while using a known tray and without a risk of damage to the tray.

The invention provides a socket for a small card, in which an installation position of a tray may be lowered owing to the presence of a transfer space for the tray and consequently, a distance from an upper surface of a housing to a rear surface of a small card may be reduced. As a result, a thickness of the socket may be reduced, resulting in miniaturization of the socket.

Further, by adjusting a depth of a transfer recess, i.e. a depth of the transfer space, it may be possible to reduce a vertical height of the socket mounted on a circuit board even while using a conventional tray, and also, it may be possible to prevent damage to the tray due to abrasion while assuring smooth sliding movement of the tray.

In the case where a bottom surface of the transfer space is made of a metal plate, the thickness of the socket may be further reduced while satisfying a strength condition of the housing.

Also, in the case where the bottom surface of the transfer space is made of the circuit board, grip portions of the tray may have a greater thickness, and this may further reduce a possibility of damage to the tray.

Furthermore, when the socket is further provided with a stopper, it may be possible to prevent the tray, on which a small card is seated, from being completely discharged out of the socket or to prevent the tray, on which the small card has been seated, from being unintentionally separated from the socket, resulting in enhanced installation reliability of the small card.

Although the several embodiments of the invention have been disclosed for illustrative purposes, those skilled in the art will appreciate that various modifications, additions and substitutions are possible, without departing from the scope and spirit of the invention as disclosed in the accompanying claims.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A socket for a small card comprising:
a housing having a metal plate with a connection terminal and an insulating layer disposed on the metal plate;
a transfer space defined along both lateral portions of the housing and having a bottom surface positioned to be lower than an upper surface of the housing;
a tray having a grip portion configured to slide in the transfer space, on which either lateral end of the small card is seated; and
a shell positioned above and substantially surrounding the tray and the housing.

2. The socket according to claim 1, wherein the insulating layer is disposed on upper and lower surfaces of the metal plate.

3. The socket according to claim 1, wherein the metal plate includes a plurality of soldering pieces positioned at a rear end thereof.

4. The socket according to claim 3, wherein the plurality of soldering pieces are electrically connected to the respective electric connection terminals and soldered to electric wires of a circuit board.

5. The socket according to claim 1, wherein the insulating layer is disposed on the upper surface of the metal plate.

6. The socket according to claim 1, wherein the bottom surface of the transfer space is made of the same material as the insulating layer.

7. The socket according to claim 1, wherein the bottom surface of the transfer space is made of the metal plate.

8. The socket according to claim 1, wherein the bottom surface of the transfer space is made of a circuit board.

9. The socket according to claim 1, further comprising a stopper positioned along a side of the shell to limit a sliding movement distance of the grip portion of the tray.

10. The socket according to claim 9, wherein the stopper includes an elastic piece protruding inward from a lateral surface of the shell.

11. The socket according to claim 10, wherein the stopper further includes first and second retention recesses formed at longitudinal front and rear positions of either sidewall portion of the grip portion such that the elastic piece is received in and is caught by one of the first and second retention recesses.

12. The socket according to claim 11, wherein the second retention recess has a greater depth than a depth of the first retention recess such that the elastic piece is more deeply inserted into the second retention recess than the first retention recess.

13. The socket according to claim 1, wherein the shell includes a rear end wall downwardly bent thereof.

14. The socket according to claim 13, wherein the rear end wall comes into contact with a rear end of the grip portion of the tray when the tray is inserted into the socket to prevent excessive insertion of the tray.
